(19) United States
(12) Patent Application Publication
(10) Pub. No.: US 2006/0011530 A1
(43) Pub. Date: Jan. 19, 2006

(54) Capillary permeation driven pottery pipe trench waste water treatment system

(76) Inventor: Jung Yong Kim, Buk-Ku (KR)

Correspondence Address: Eugene Oak, Ph.D., J.D.;Patent Attorney, 610 S. Van Ness Ave., Los Angeles, CA, 90005, US

(21) Appl. No.: 10/892,556

(22) Filed: Jul. 16, 2004

(51) Int. Cl. C02F 3/00

(52) U.S. Cl. 210/170

(57) ABSTRACT

A pottery trench system treats the down stream wastewater from a soil covered biological septic tank without power. The wastewater flows through porous pottery pipes buried underground surrounded with rock filter. U-shape polyolefin primary pipes buried under the pottery pipes prevent direct contamination of the underground water with the wastewater. Secondary porous pipes are buried under the polyolefin pipes with one end exposed to the air. Air is supplied from the pores of the porous pipes to the soil surrounding the trench. The system of this invention uses neither artificial chemicals nor powers. Maintenance cost is low. The system is constructed utilizing naturally occurring materials and plants. The effluent, water, exceeds the quality of needed for irrigation recycling or other effluent disposal methods.

The present invention relates to an environmentally affirmative trench system treating effluents from soil covered biological septic tanks for decomposition of household sewage.

### BACKGROUND OF THE INVENTION

1. FIELD OF INVENTION

The present invention relates to a more environmentally affirmative trench system treating household sewages from a soil covered multi-step biochemical septic tank. Secondary contamination of the underground water by the wastewater soaked out of the trench is minimized. Additional oxygen for the microorganisms in the soil, decomposing impurities in the wastewater, is supplied from bottom of the trench.

2. Description of the Prior Art

Many of previous U.S. patents teach various methods of treating wastewater from septic tanks. U.S. Pat. Nos. 5,707,513; 5,645,732; 4,971,690; 4,826,601; 4,824,572; 4,100,073 teach to use simple filters and chemical treatments.

U.S. Pat. No. 4,895,645 to Zorich teaches the use of a closed multi chamber multi media biological filter tank between the septic tank and the drain field with a complex control system. U.S. Pat. No. 6,264,838 to Nivens teaches a method of a complete synergetic on site wastewater recycle system. The system consists of multi step biological septic tank of conventional type, a rock/plant filter, a dosing chamber, a shallow horizontal flow pulsed planted aggregate filter, and effluent holding tank. The system does not use power. The materials of construction are natural. However, the impervious membrane isolating the shallow aggregate filter from the soil can block the air permeation to the surrounding soil and makes it rot destroying the biological environment in the soil.

The last two technologies utilize biological methods. They are very complex for a normal house wastewater treatment. They are environmentally imperfect.

U.S. Pat. No. 6,464,865 to Tipton, U.S. Pat. No. 6,270,661 to Jowett, U.S. Pat. No. 5,989,416 to Gorton's, U.S. Pat. No. 5,676,828 to Kallenbach's, U.S. Pat. No. 5,382,363 to Boylen, U.S. Pat. No. 4,218,318 to Niimi, U.S. Pat. No. 4,100,073 to Hopcroft, U.S. Pat. No. 3,680,704 to Schaefer, U.S. Pat. No. 1,950,841 to Crawford, and U.S. Pat. No. 956,665 to Ashley illustrate trench sewage treatment systems utilizing porous discharge pipes.

However, all of the prior art do not illustrate an additional layer to protect ground water from contamination by the wastewater leaks from the porous pipes. In current invention, U-shape half non-permeable plastic pipe is buried under the porous trench (terra-cotta) to prevent direct contamination of underground water by the wastewater.

### SUMMARY OF THE INVENTION

It is the object of this invention to provide a more simple and environmentally affirmative system treating the wastewater from multistage biological septic tanks. The system is simple in design and operation, economical to construct, operate, and maintain.

FIG. 1 is a schematic plane geometry showing the layout of the system. The structure is buried underground. Garden grass and flowers are planted on the soil to provide a pleasant view, adequate for installation in a normal house yard. No instruments consuming power are used.

System of this invention utilizes pottery pipes, U shaped polyolefin half pipes, soil, stone chips and local plants for the microorganisms living in the area.

The invention provides all the synergistic artificial conditions to naturally treat the waste water to produce an effluent clean enough to be used as household water for toilet, car washing and garden sprinkler while using no artificial chemicals, and no treatment method step requiring frequent maintenance.

### BRIEF DESCRTIPTION OF THE DRAWINGS

FIG. 1 is a schematic plane geometry showing the lay out of the system.

FIG. 2 is a cross sectional view of the primary pottery pipe trench system.

FIG. 3 is a cross sectional view of supplementary secondary porous pipe surrounded with rock filter for air supplying.

### DETAILED DESCRIPTION OF THE PREFERRED EMBODIMENTS

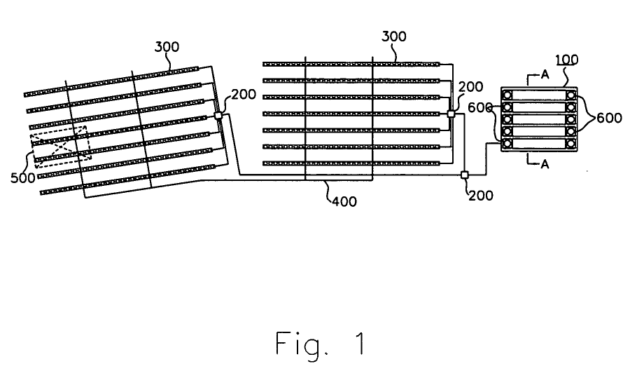

FIG. 1 is the schematic plan geometry showing the lay out of the system of this invention. Sewages treated in the soil covered biological septic tank (100) are distributed to the primary pottery trenches (300) by distributor (200). Supplementary secondary porous pipe system (400) buried under the pottery trench (300) in the transversal direction to the primary pottery trenches (300), surrounded by rock filter, supplies the air for microorganisms in the soil and reserve the overflowed wastewater. Effluents are sampled for evaluation at the sampling port (500). Two sets of trenches are installed in series to meet the over flow of the wastewater.

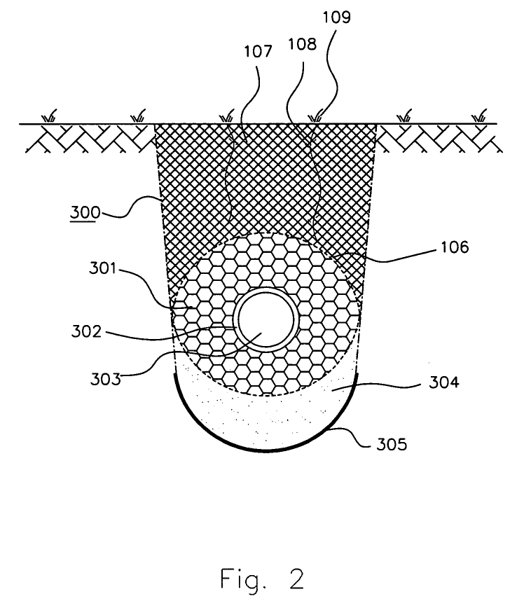

FIG. 2 is the cross sectional view of the primary pottery piped trench system. When wastewater is introduced into the pottery pipe (303), the water soaks out of the pottery through the pores at the wall (302). Then the water diffuses into radiation direction by the capillary permeation through the pores in the rock filter (301), which is wrapped with a mesh net (106). Water, soaked out to the bottom direction of the pottery pipe (302), is blocked by the U shape polyolefin half pipe (305) and captured in the sand layer (304), which fills the U shaped half pipe (303). The water captured in the sand layer (304) diffuses upper direction by a capillary permeation. No pumps are needed to deliver the water to the effluent end. Water, soaked out of the pottery tubes, is absorbed by the root (108) of the plants (109) in the soil (107). Impurities in the water are used as fertilizer for the plants and food for microorganisms in the soil.

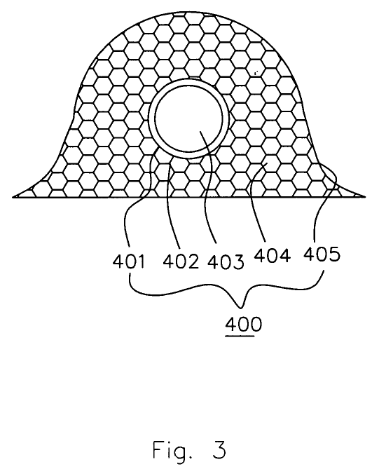

FIG. 3 is a cross sectional view of supplementary secondary porous pipe surrounded with rock filter for air supplying. The air supplying pipe system (400) is buried under the primary pottery trench (300) in transversal direction thereof. Rock filters (404) with pores (402) are layered on the meshes (405) and secondary pottery pipes (403) are installed. One side of these secondary porous pipes is exposed to the air from above ground. The roles of these porous pipes are: 1) to supply air to the microorganisms living in the soil (107); and 2) to reserve the overflowed wastewater.

Combination of the above mechanisms endowed by the structure of this invention enables non power driven waste water treating system easy to install, maintain and economic. Environmentally affirmation is another strong point of this system.

What is claimed is:

1. A trench type wastewater treatment system comprised of; 1) primary porous pottery pipes, 2) rock filters surrounding the primary porous pottery pipes, 3) mesh net wrapping the rock filters, 4) sand layer under the net wrapped rock filter, 5) U shape plastic half pipes under the sand layer, 6) supplementary secondary porous pipes, which are installed in transversal direction to the primary porous pottery pipes beneath a U shape half pipe, one end of which is open to the air for supplying air to the soil and for reversing overflow of the wastewater from the septic tank, 7) secondary rock filters surrounding the secondary porous pipes, 8) gauzes wrapping the secondary rock filters, and 9) a soil covered biological septic tank, which is connected to the primary porous pottery pipes via distributors, and the surface of which is covered with planted grasses and flowers of the area.
